(19) United States
(12) Patent Application Publication
(10) Pub. No.: US 2017/0006831 A1
(43) Pub. Date: Jan. 12, 2017

(54) PHOTOSENSITIVE CAT TEASER

(71) Applicant: TONGFU MANUFACTURING CO., LTD., Nanjing (CN)

(72) Inventor: Wen ZHANG, Nanjing (CN)

(21) Appl. No.: 14/859,997

(22) Filed: Sep. 21, 2015

(30) Foreign Application Priority Data
Jul. 10, 2015 (CN) 201520496240.5

(51) Int. Cl. A01K 15/02

(52) U.S. Cl. CPC A01K 15/025

(57) ABSTRACT

The present utility model relates to the field of pet toys. A photosensitive cat teaser is disclosed, mainly including a cat teaser casing, a photoresistor being disposed on a casing body of the casing, the photoresistor being integrated in an integrated circuit, a motor with a motor shaft being integrated on the integrated circuit, and a toy member being inserted on the motor shaft. By means of a photoresistor, a toy member rotates when a cat approaches, to make it more interesting for the cat to interact with the toy member. By means of the photosensitive cat teaser disclosed in the present utility model, an effect of cat teasing can be enhanced, and playing of cats becomes more interesting.

### BACKGROUND

Technical Field

The present utility model relates to a photosensitive cat teaser, and belongs to the field of pet toys.

Related Art

Cats are common domestic pets. To enhance interactivity with a cat, persons skilled in the art devote themselves to research and development of pet toys that can draw the attention of pet cats and meet the nature of cats.

It is found that cats are born with interests in articles such as yarn and feathers; however, this type of articles usually have excessively loose structures, and a large quantity of floating bits and pieces are easily produced during the playing of cats.

### SUMMARY

An inventive object is to develop a pet toy based on inborn likings of cats for articles such as yarn and feathers, so as to meet playing requirements of cats and at the same time avoid floating bits and pieces caused by excessive falling off during playing of such type of loose articles.

To achieve such an inventive object, a photosensitive cat teaser is disclosed, and mainly includes a cat teaser casing, a photoresistor being disposed on a casing body of the casing, the photoresistor being integrated in an integrated circuit, a motor with a motor shaft being integrated on the integrated circuit, and a toy member being inserted on the motor shaft.

Naturally, to ensure normal working of electronic components such as the integrated circuit and the photoresistor, a battery is required to be correspondingly installed to supply power, and at the same time a switch is designed to control supply and shutoff of electric energy.

The photoresistor is disposed outside the casing body. When a cat approaches, the photoresistor is triggered, such an approach signal is transferred into the integrated circuit by using the photoresistor, a swing program preset in the circuit is started, the motor is controlled to start, rotation of the motor shaft further occurs, and further the toy member is driven to rotate. To accomplish operations such as control, correspondingly, for the part of the integrated circuit, for example, circuit design, reference may be made to an existing mature method for designing an integrated circuit.

Preferably, the motor shaft is formed of a first motor shaft located above the motor and a second motor shaft located below the motor, and same or different toy members are separately inserted on the two motor shafts.

Furthermore, a preferred manner is disclosed, that is, a toy insertion disk is used, a fixing sleeve tube being formed at the center of the insertion disk, and the toy insertion disk being fixed on the motor shaft by using the fixing sleeve tube, a fixing hole is opened on a disk surface of the insertion disk, and the toy member being fixed inside the fixing hole.

The motor shaft drives the toy insertion disk to rotate. The insertion disk rotates about the motor shaft as an axis. Along with the rotation of the insertion disk, the toy member fixed on the disk surface of the insertion disk undergoes a circumferential movement with the center of the insertion disk being a rotation center, so that a range of rotation of the toy member may be increased, and more fun is provided.

Preferably, when the insertion disk is used, a fixing tube is preferably inserted inside the fixing hole of the insertion disk, and the toy member is inserted inside the fixing tube.

Further preferably, it is further disclosed that the casing body of the casing is a triangular dome casing body.

The triangular dome casing body is beautiful, and at the same time, when a pet is playing, a contact surface with the toy member is large. Such a triangular structure is also more stable.

Finally, it is further disclosed that the toy member is a feather bundle and/or yarn. When being assembled, feather bundles may be inserted above and below, or a feather bundle and yarn may be separately inserted above and below. Preferably, a feather bundle is inserted above, and yarn is inserted below.

By means of a photoresistor, a toy member rotates when a cat approaches, to make it more interesting for the cat to interact with the toy member. By means of the photosensitive cat teaser disclosed in the present utility model, an effect of cat teasing can be enhanced, and playing of cats becomes more interesting.

### BRIEF DESCRIPTION OF THE DRAWINGS

FIG. 1 is a schematic view of a photosensitive cat teaser;

FIG. 2 is a schematic bottom view of the photosensitive cat teaser;

FIG. 3 is a schematic exploded view of the photosensitive cat teaser; and

FIG. 4 is a schematic sectional view of a position in which a motor is connected.

### DETAILED DESCRIPTION

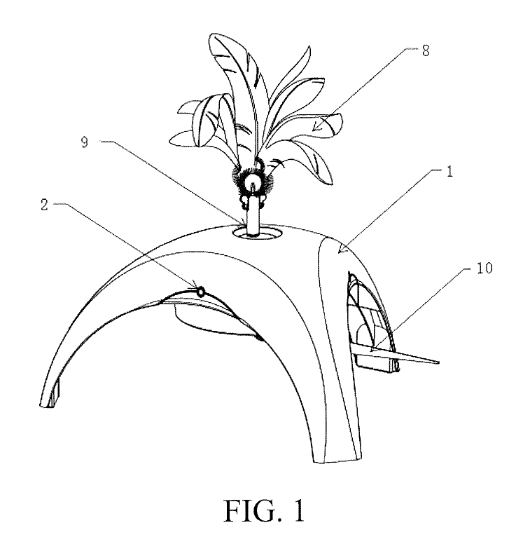

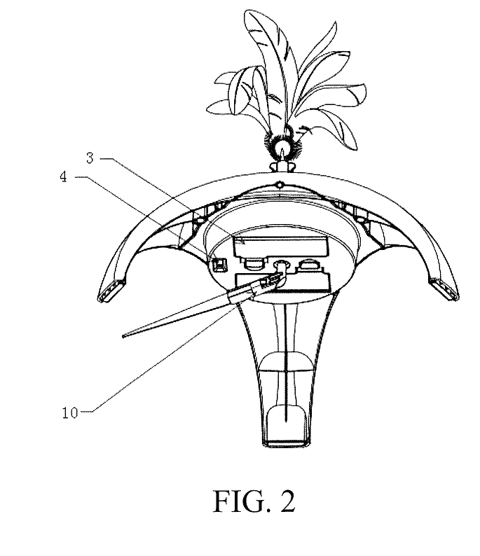

A photosensitive cat teaser disclosed in FIG. 1 and FIG. 2 mainly includes a triangular dome casing 1. A photoresistor 2 is disposed on the casing 1. Here, as a preferred manner, the photoresistors 2 are disposed on all three side surfaces.

The photoresistor is integrated in an integrated circuit. The integrated circuit is located inside the casing 1. To ensure supply of power to members such as the photoresistor, a battery chamber 3 and a power switch 4 for controlling supply and shutoff of power are further disposed.

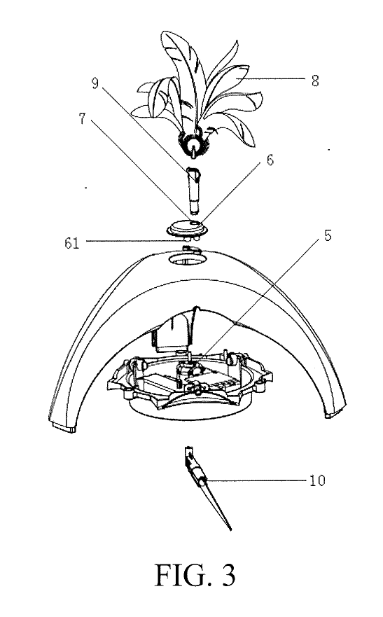

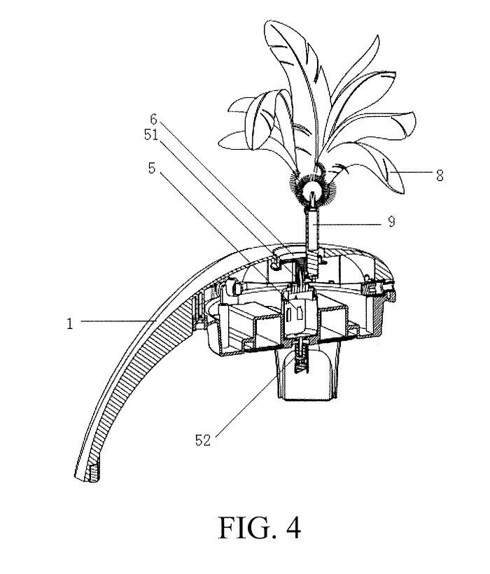

A motor 5 with a motor shaft is integrated on the integrated circuit. As shown in FIG. 4, the motor shaft is formed of a first motor shaft located above the motor 51 and a second motor shaft located below the motor 52. Further, with reference to FIG. 3, a toy insertion disk 6 is inserted on the first motor shaft 51, a fixing sleeve tube 61 is framed at the center of the insertion disk 6 and is fixed on the first motor shaft 51 by using the fixing sleeve tube, a fixing hole 7 is opened on a disk surface of the insertion disk 6, and a feather bundle 8 is fixed inside the fixing hole 7 by using a fixing tube 9. A bottom toy 10 is directly inserted on the second motor shaft 52.

During teasing of a cat, the power switch 4 is first closed, and the photoresistor 2 starts to work. When the cat blocks the photoresistor 2, the photoresistor 2 feeds back such a signal into the integrated circuit. A rotation speed of the motor 5 is preset in the integrated circuit. Under the control of such a preset program, the motor runs and drives the motor shaft to move. The first motor shaft 51 moves to drive the insertion disk 6 to move coaxially with the first motor shaft 51, and enables the feather bundle 8 fixed on the insertion disk 6 to move circumferentially, and at the same time the second motor shaft 52 moves and drives the bottom toy 10 directly inserted on the second motor shaft 52 to rotate coaxially.

Every time the cat interferes with the photoresistor 2, the feather bundle and the bottom toy undergo one rapid rotation movement and stop immediately. When the cat interferes with the photoresistor 2 a next time, the rotation movement is started again. The process repeats. When the cat leaves or does not interfere with the photoresistor 2, the feather bundle and the bottom toy stay still and do not rotate.

1. A photosensitive cat teaser, comprising a cat teaser casing, a photoresistor being disposed on a casing body of the casing, the photoresistor being integrated in an integrated circuit, a motor with a motor shaft being integrated on the integrated circuit, and a toy member being inserted on the motor shaft.

2. The photosensitive cat teaser according to claim 1, wherein the motor shaft is formed of a first motor shaft located above the motor and a second motor shaft located below the motor, and same or different toy members are separately inserted on the two motor shafts.

3. The photosensitive cat teaser according to claim 2, further comprising a toy insertion disk, a fixing sleeve tube being formed at the center of the insertion disk, the toy insertion disk being fixed on the motor shaft by using the fixing sleeve tube, a fixing hole is opened on a disk surface of the insertion disk, and the toy member being fixed inside the fixing hole.

4. The photosensitive cat teaser according to claim 3, wherein a fixing tube is inserted inside the fixing hole, and the toy member is inserted inside the fixing tube.

5. The photosensitive cat teaser according claim 1, wherein the casing body of the casing is a triangular dome casing body.

6. The photosensitive cat teaser according to claim 1, wherein the toy member is a feather bundle and/or yarn.

7. The photosensitive cat teaser according to claim 2, wherein the casing body of the casing is a triangular dome casing body.

8. The photosensitive cat teaser according to claim 3, wherein the casing body of the casing is a triangular dome casing body.

9. The photosensitive cat teaser according to claim 4, wherein the casing body of the casing is a triangular dome casing body.
